(19) United States
(12) Patent Application Publication
(10) Pub. No.: US 2017/0126581 A1
(43) Pub. Date: May 4, 2017

(54) SYSTEM FOR AUTOMATIC RESOURCE RE-ALLOCATION BASED ON RESOURCE UTILIZATION DETERMINATION

(71) Applicant: BANK OF AMERICA CORPORATION, Charlotte, NC (US)

(72) Inventors: Cameron D. Wadley, Waxhaw, NC (US); Minh Nguyen Vuong, Clovis, CA (US)

(21) Appl. No.: 14/928,789

(22) Filed: Oct. 30, 2015

(51) Int. Cl. H04L 12/917

(52) U.S. Cl. CPC H04L 47/76

(57) ABSTRACT

The present invention provides automatic resource re-allocation based on resource utilization determination. Specific the invention provides for logically determining the volume of re-allocation based on monitoring prior use patterns of the resources and future planned utilization. In addition, resources may be monitored to determine the optimal time for re-allocating resources. In response to the invention determining a volume of re-allocation and, in some embodiments, time for re-allocation, resources can be automatically re-allocated.

### FIELD

In general, embodiments of the invention relate to resource management and, more particularly, systems, method and automatically determining resource re-allocation based on resource utilization determination.

### BACKGROUND

In managing resources it is necessary to make intelligent and informed decisions as to re-allocation of resources. In this regard, intelligent decisions as to re-allocation need to make sure that the proper volume or amount of resources are re-allocated. In order to make such an intelligent or informed decision, it is necessary to know resource utilization history, as well as, planned future utilization of resources. In addition, insuring proper volume or amount of re-allocation it may also be beneficial to properly time the re-allocation, so that resources can be provide maximum benefit

Therefore, a need exists to develop systems, apparatus, computer program products, methods and the like that provide for automatic resource re-allocation. Such systems, apparatus, computer program products, methods should re-allocate resources such that the volume of resources or amount of resources re-allocated is based on one or more of historical resource utilizations and/or future scheduled resource utilizations. In addition, re-allocation of resources may take into account performance of the resources for the purpose of properly determining the timing for re-allocation.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, systems, computer program products, methods or the like for automated resource re-allocation based on monitoring/assessing resource utilization. In specific embodiments of the invention, past/historical resource utilization is monitored and/or future/scheduled resource utilization is assessed to logically and intelligently determine the volume or amount resources available for automatic re-allocation. In other embodiments of the invention, performance of the resource is evaluated/determined to logically and intelligently determine the timing associated with the automatic re-allocation.

A system for automatic resource re-allocation based on resource utilization determination defines first embodiments of the invention. The system includes a computing platform having a memory and at least one computing processor in communication with the memory. The system additional includes a historical resource utilization database stored in the memory and configured to catalog records of users' historical resource utilization and a scheduled resource utilization database stored in the memory and configured to catalog records of users' future scheduled resource utilization. In addition the system includes a first resource monitoring engine that is stored in the memory and executable by the computing processor. The first resource monitoring engine is configured to (1) access the historical resource utilization database to monitor users' historical resource utilization, and (2) access the scheduled resource utilization database to assess users' future planned resource utilization. Additionally, the system includes a resource re-allocation engine that is stored in the memory and executable by the computing processor. The re-allocation engine is configured to (1) logically determine a volume of resources to re-allocate based on at least one of users' historical resource utilization and future planned resource utilization, and (2) automatically re-allocate the determined volume of resources.

In specific embodiments the system additionally includes a second resource monitoring engine that is stored in the memory and executable by the computing processor. The second resource monitoring engine is configured to monitor performance of users' resource allocation, such as an investment resource allocation. In such embodiments of the system, the resource re-allocation engine is furthered configured to (3) logically determine a timing for re-allocation of resources based on the performance of users' resource allocation and (2) automatically re-allocate the determined volume of resources in accordance with the determined timing for re-allocation.

In other specific embodiments of the system the historical resource utilization database is further defined as a transaction history database, such as a financial transaction history database that is configured to catalog records of users' transaction history, such as financial transaction history. In such embodiments of the system, the first resource monitoring database is configured to access the transaction history database to monitor users' transaction history and the resource re-allocation engine is configured to logically determine the volume of resources to re-allocate based on a users' transaction history.

In other specific embodiments of the system the scheduled resource utilization database is further defined as a future transaction database that is configured to catalog records of users' future scheduled transactions, such as future transfers, recurring payments or the like. In such embodiments of the system, the first resource monitoring database is configured to access the future transaction database to assess users' future scheduled transactions, and the resource re-allocation engine is configured to logically determine the volume of resources to re-allocate based on a users' future scheduled transactions.

In further specific embodiments of the system, the resource re-allocation engine is further configured to automatically re-allocate the determined volume of resources from lower yield resource, such as transferring assets from a checking account to a prospectively higher yield resource, such as an investment/brokerage account or other investment vehicle, real property, commodities or the like. In other specific embodiments of the system, the resource re-allocation engine is further configured to automatically re-allocate the determined volume of resources from prospectively higher yield resources, such as assets in an investment/brokerage account or other investment vehicle, real property, commodities or the like to a lower yield resource, such as a checking account or the like.

A computer-implemented method for automatic resource re-allocation based on resource utilization determination defines second embodiments of the invention. The method includes accessing a historical resource utilization database to monitor users' historical resource utilization and accessing a scheduled resource utilization database to assess users' future planned resource utilization. The method further includes determining a volume (i.e., amount) of resources to re-allocate based on at least one of users' historical resource utilization and future planned resource utilization and, in response to determining the volume of resources to re-allocate, automatically re-allocating the determined volume of resources.

In specific embodiments the method further includes monitoring performance of users' resource allocation and determining a timing for re-allocation of resources based on the performance of users' resource allocation, such as performance of users' investment resource allocation. In such embodiment of the method, automatically re-allocating further includes automatically re-allocating the determined volume of resources in accordance with the determined timing for re-allocation.

In other specific embodiments of the method accessing the historical resource utilization database is further defined by accessing a transaction history database, such as a financial transaction database that is configured to catalog records of users' transaction history. In such embodiments of the method, determining the volume of resources to re-allocate is further defined by determining the volume of resources to re-allocate based on a users' transaction history.

In still further specific embodiments of the method accessing the scheduled resource utilization database is further defined by accessing a future transaction database, such as a scheduled financial transaction database, that is configured to catalog records of users' future scheduled transactions, such as scheduled transaction/payments, recurring payments/debits and the like. In such embodiments of the method, determining the volume of resources to re-allocate is further defined by determining, by the computing device processor, the volume of resources to re-allocate based on a users' future scheduled transactions.

In still further embodiments of the method, automatically re-allocating is further defined further by automatically re-allocating the determined volume of resources from a lower yield resource, such as a checking account to a prospectively higher yield resource, such as an investment/brokerage account or another investment vehicle, such as real property, commodities or the like. In other related embodiments of the method, automatically re-allocating is further defined further by automatically re-allocating the determined volume of resources from a prospectively higher yield resource, such as an investment/brokerage account or another investment vehicle, such as real property, commodities or the like, to a lower yield resource, such as a checking account or the like.

A computer program product including a non-transitory computer-readable medium defines third embodiments of the invention. The computer-readable medium includes a first set of codes for causing a computer to access a historical resource utilization database to monitor users' historical resource utilization. In addition, the computer-readable medium includes a second set of codes for causing a computer to access a scheduled resource utilization database to assess users' future planned resource utilization. Additionally, the computer-readable medium includes a third set of codes for causing a computer to determine a volume of resources to re-allocate based on at least one of users' historical resource utilization and future planned resource utilization. Moreover, the computer-readable medium includes a fourth set of codes for causing a computer to, in response to determining the volume of resources to re-allocate, automatically re-allocate the determined volume of resources.

Thus, systems, apparatus, methods, and computer program products herein described in detail below provide for automated resource re-allocation based on monitoring/assessing resource utilization. In specific embodiments of the invention, past/historical resource utilization is monitored and/or future/scheduled resource utilization is assessed to logically and intelligently determine the volume or amount resources available for automatic re-allocation. In other embodiments of the invention, performance of the resource is evaluated/determined to logically and intelligently determine the timing associated with the automatic re-allocation.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a schematic diagram of a system for automatic resource re-allocation based on resource utilization, in accordance with embodiments of the present invention;

FIG. 2 provides a block diagram of a high level system for automatic resource re-allocation based on resource utilization, in accordance with embodiments of the present invention;

FIGS. 3 and 4 provides a block diagram of detailed system for automatic resource re-allocation based on resource utilization specifically, reallocating financial assets, in accordance with embodiments of the invention; and

FIG. 5 provides a flow diagram of a method for automatic resource re-allocation based on resource utilization, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for automated resource re-allocation based on monitoring/assessing resource utilization. In specific embodiments of the invention, past/historical resource utilization is monitored and/or future/scheduled resource utilization is assessed to logically and intelligently determine the volume or amount resources available for automatic re-allocation. In other embodiments of the invention, performance of the resource is evaluated/determined to logically and intelligently determine the timing associated with the automatic re-allocation.

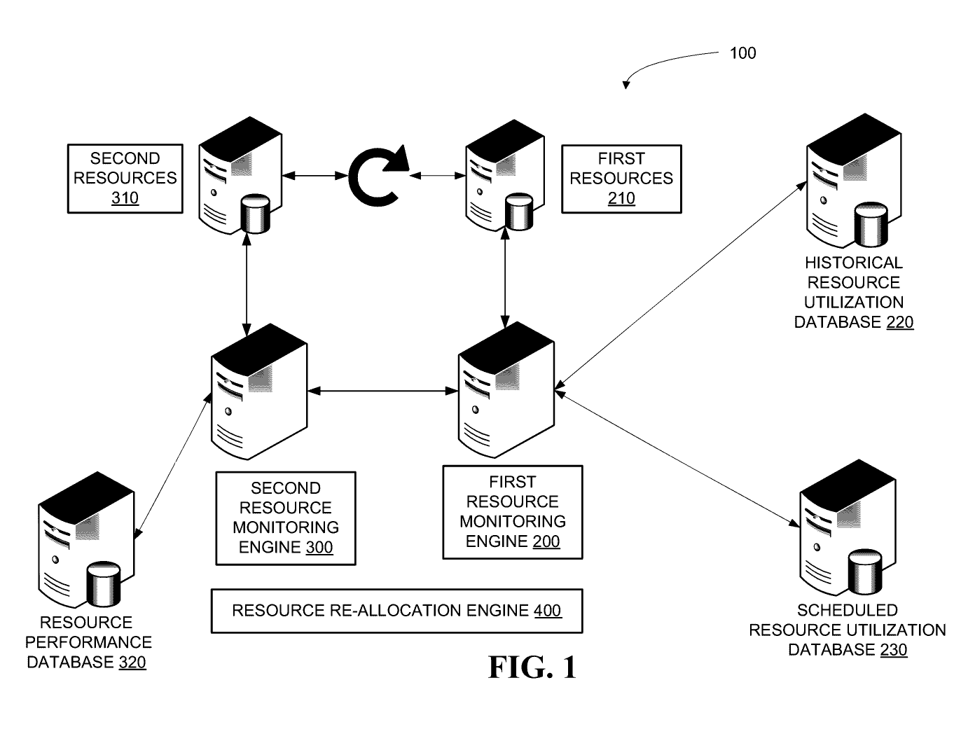

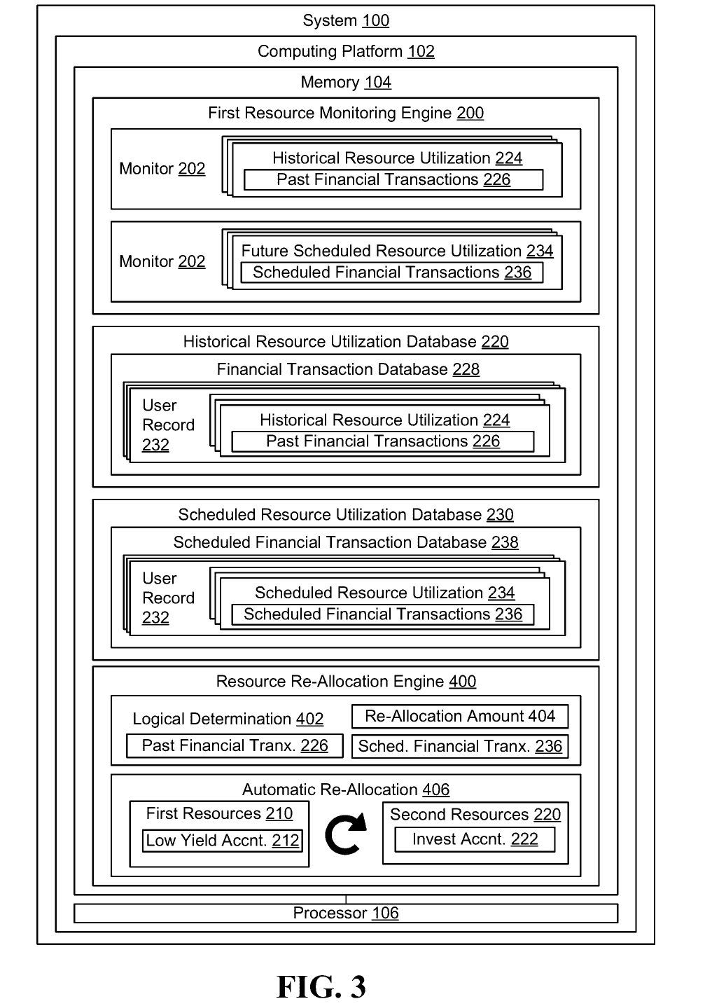

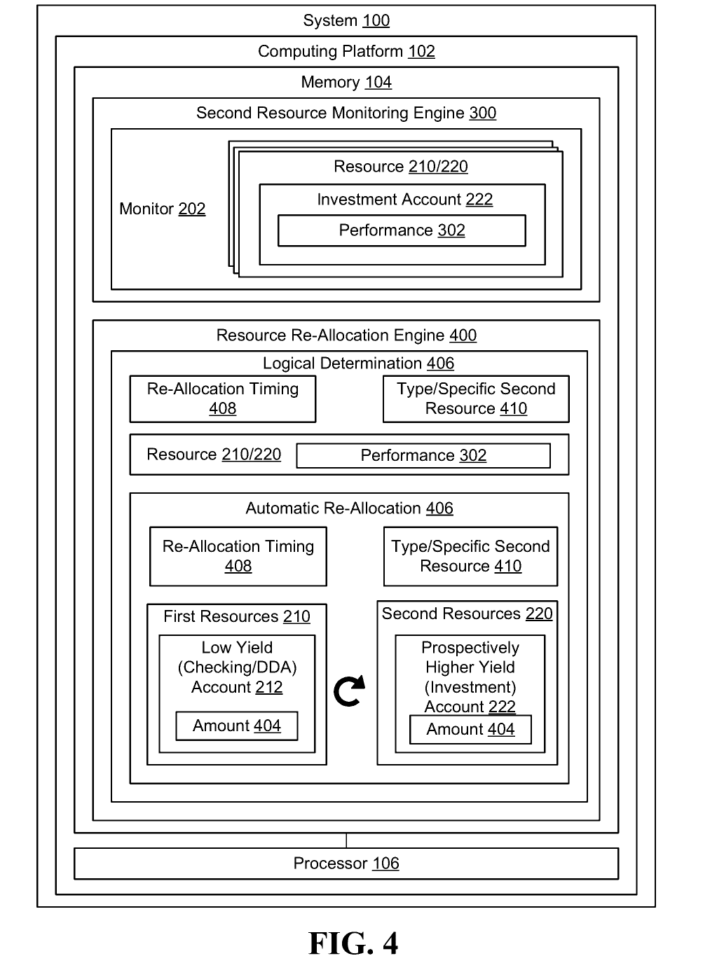

Referring to FIG. 1, a block diagram is provided of a system 208 configured for automatic re-allocation of resources based on resource utilization; in accordance with embodiments of the present invention. In specific embodiments of the invention, discussed in detail below, and specifically in reference to FIGS. 3 and 4, the resources that are being re-allocated are financial assets, which are re-allocated by automatically transfers the assets (i.e., monetary funds or the like) from one type of financial account to another type of financial account. Specifically, the re-allocation of resources may comprise automatic transfer of funds from a low yield account, such as checking account/Demand Deposit Account (DDA) to a prospectively higher yield account, such as an investment account or the like or vice versa (i.e., from the prospectively high yield account to the lower yield account).

System 100 includes a first resource monitoring engine 200 that is configured to access historical resource utilization database 220 to monitor users' historical resource utilization. For example, in those embodiments of the invention in which the first resource 210 being re-allocated is funds in a checking account/DDA, the historical resource utilization database may be a financial transaction database, which stores records of user's financial transactions (i.e., debits/withdrawals, purchases, credits, transfers and the like). In addition, first resource monitoring engine 200 is configured to access scheduled resource utilization database 230 to assess/monitor user's future planned/scheduled resource utilization. For example, in those embodiments in which the first resource 210 being re-allocated is funds in a checking/DDA account, the scheduled resource utilization database 230 may be a scheduled transaction database, which stores records of users' planned future financial transactions (e.g., known recurring payments/transactions, scheduled billpay transactions and the like), including proximate or definitive date(s) and amount(s). It should be noted that while FIG. 1 indicates separate databases 220 and 230 for the historical resource utilization and scheduled resource utilization, it is also feasible, and within the confines of the invention, to store both the historical resource utilization records/data and the scheduled resource utilization records/data in one consolidated database.

System 100 additionally includes a resource re-allocation engine 400 that is configured to determine a re-allocation volume or amount based on at least one of the users' historical resource utilization and/or future planned/scheduled resource utilization and, in response to determining the volume/amount, automatically re-allocate the first resources 210 to the second resources 310.

It should be noted that the determination of the re-allocation amount is a logical determination that may be based on other information and/or factors available to the resource re-allocation engine 400. For example, in the those embodiments in which resource re-allocation is transferring funds amongst financial accounts, the other factors may include, but are not limited to, time of year, upcoming events having a financial impact, relationships and the like. In this regard, according to specific embodiments the resource re-allocation engine 400 makes a logical decision as to whether the first resource 210 has surplus based on historical use of the first resource 210 and planned future use of the first 210, as well as any other relevant information available to the engine 400, and, if surplus is determined to exist, automatically re-allocates the surplus in the first resource 210 to the second resource 310. For example, the logical determination made by resource re-allocation engine 400 may take into generic information, such as time of year (e.g., higher spend at year end due to holiday expenditures or the like, higher utility payments during the winter (e.g, heat) and summer (e.g., air conditioning), higher need for disposable income/funds proximate to tax deadlines and the like). Moreover, the logical determination may take into account user-specific time data (e.g., knowledge of an upcoming life event, such as birthday/anniversary, vacation, wedding, tuition or the like), which may be determined based on access to financial transactional data or the like.

Additionally, in those instances in which the re-allocation of resources is from a potentially higher-yield resource, such as an investment account to a lower yield account, such as a checking/DDA account (i.e., liquidation of assets) the logical determination may take into account events that may impact, financial performance or increase volatility, of the resources/assets. For example, a natural disaster in a specific geographic area, currency fluctuations in specified country or the like may have a direct or indirect effect on the performance of a stock/mutual fund or security held in the portfolio of the user. In such instances the logical determination made by resource re-allocation engine 400 may take into account the magnitude of the event and the impact (both positive and negative impacts) of the event on the portfolio/resources in making decisions as to whether reallocation is warranted (i.e., whether resources/assets should be liquidated and moved from the investment account to a lower yield account, such as a checking account or, conversely, whether timing is right to move resource funds from the lower yield account to an investment account.

In further embodiments of the invention, the logical determination may take into account relational information impacting future use of resources/funds. For example, the system 100 of the present invention may have access to relationship data that indicate which individual, parties or entities are associated with the user from an indirect financial relationship/obligation standpoint. In such instances, resource re-allocation engine 400 may identify those individual, parties or entities that have an indirect financial relationship/obligation to or from the user and assess those individuals, parties or entities current or future financial needs; making an assumption that if those individual, parties or entities have upcoming financial obligations and accounts indicate a likely shortfall at the time the obligation comes due, the user would be likely to loan resources/funds to the individual, part or entity or otherwise provide for the shortfall. Such an assumption may made through the user's historical financial data, which may indicate that the user has, in the past, provided resources/funds to the individual, party or entity when they have experienced a shortfall. In such instances the resource re-allocation engine 400 may choose to forego or lessen the volume/amount of a resource re-allocation, since resources/funds that may have otherwise been re-allocated may be needed to account for the shortfall of the related individual, party or entity.

Based on configuration of the system 100, the determination may be dynamic determination that occurs at any point in time, or the decision may occur at a predetermined point in time, such as monthly or the like. For example, in those embodiments in which the re-allocation of resources is transferring funds from a checking account/DDA to an investment account, the determination may occur at a predetermined time, such as at or near the end of a month (or monthly cycle). In this regard, the resource re-allocation engine 400 may make the re-allocation amount determination based previous month(s) historical financial transaction data and/or next month(s) planned financial transaction (e.g., upcoming predicted recurring payments/transactions, upcoming scheduled billpays, upcoming deposits, such as paycheck deposits and the like).

In optional embodiments of the invention, the system 100 may additionally include a second resource monitoring engine 300 that is configured to access one or more resource performance databases 320 and or other information outlets to monitor the performance of the second resources 310. In such optional embodiments of the invention, the resource re-allocation engine 400 may determine at least one of the timing for re-allocation and/or the type or specific second resource 310 to which the resources should be re-allocated to and. in response to determining the timing and/or second resource, automatically re-allocate the determined volume/amount resources to the determined second resource 310 and based on the determined timing. For example, in those embodiments of the invention in which the resources being allocated are transfer of funds from one financial account to another financial account, specifically to an investment account or vehicle, the second resource monitoring engine 300 may monitor the performance of a user's current investment accounts or vehicles and/or other potential investment vehicles/options and the resource allocation engine 400 may make logical decisions as to which type of, or specific, investment account or vehicle the re-allocation should be applied and the timing for re-allocation (e.g., the opportune time for investing in stock, mutual fund, commodity, real property or the like).

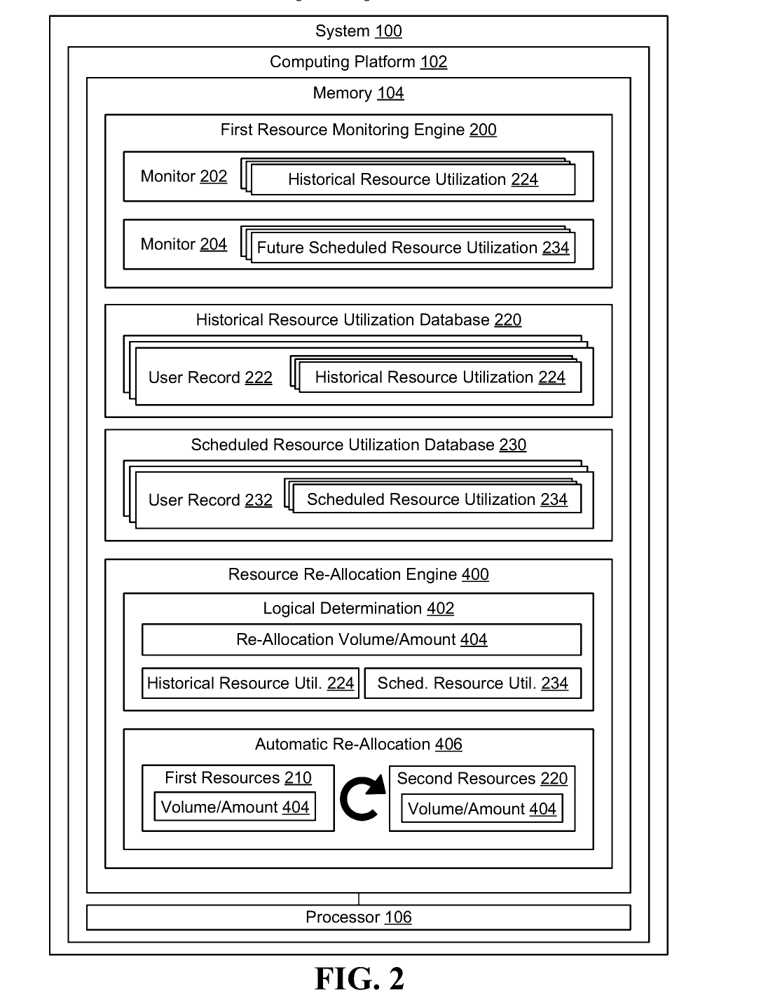

Referring to FIG. 2, shown is a high-level block diagram of a system for automatic resource re-allocation based on resource utilization, in accordance with embodiments of the present invention. The system includes a computing platform 102 having a memory 104 and at least one processor 106 in communication with the memory 104. The computing platform 102 is not limited to a single computing device, but rather may comprise multiple different computing devices, such as servers, databases and the like. The system 100 includes first resource monitoring engine 200 that is stored in the memory 104, executable by the processor 106 and configured to access historical resource utilization database 220 to monitor 202 user records 222 pertaining to historical resource utilization 224. Further, first resource monitoring engine 200 is configured to access scheduled resource utilization database 230 to monitor 204 user records 232 pertaining to future planned/scheduled resource utilization 234. Based on system 100 configuration, first resource monitoring engine 200 may access databases 220 and 230 dynamically on a continuous or as-needed basis or may be configured to access the databases 220 and 230 on a predetermined schedule, such prior to the resource re-allocation engine 400 making a determination as to re-allocation volume/amount 404.

System 100 additionally includes resource re-allocation engine 400 that is stored in the stored in the memory 104, executable by the processor 106 and configured to make a logical determination 402 as to re-allocation volume/amount 404 based on at least one of historical resource utilization 224 and/or scheduled resource utilization 234 and any other factors or relevant information known or accessible to the resource re-allocation engine 400. In response to determining the re-allocation volume/amount, the resource re-allocation engine 400 is configured to automatically re-allocate the determined volume/amount 404 of the first resource 210 to the second resource 220. In this regard, the resource re-allocation engine 400 is configured to determine the surplus in first resource 210 based on previous resource utilization 224 of the first resource 210, planned future resource utilization 234 of the first resource 220 and any other information factors available to the engine 400, and in response to determine the surplus volume/amount 404, re-allocate the surplus volume/amount 404 to the second resource 220.

Referring to FIGS. 3 and 4 shown are more detailed block diagram of a system 100 for resource re-allocation based on resource utilization, in accordance with embodiments of the present invention. Specifically, FIGS. 3 and 4 highlight those embodiments of the invention in which the resources being re-allocated are assets/funds with financial accounts, specifically from a low yield account, such as a checking account/DDA to a prospectively higher yield account/vehicle, such as an investment account, commodity, real estate or the like. As previously discussed, system 100 includes a computing platform 102 having a memory 104 and one or more processors 106 in communication with the memory 104. Moreover, the computing platform 102 will comprise multiple devices, such as servers, databases and the like.

Memory 104 may comprise volatile and non-volatile memory, such as read-only and/or random-access memory (RAM and ROM), EPROM, EEPROM, flash cards, or any memory common to computer platforms. Further, memory 104 may include one or more flash memory cells, or may be any secondary or tertiary storage device, such as magnetic media, optical media, tape, or soft or hard disk. Moreover, memory 104 may comprise cloud storage, such as provided by a cloud storage service and/or a cloud connection service.

Further, processor 106 may be an application-specific integrated circuit (“ASIC”), or other chipset, processor, logic circuit, or other data processing device. Processor 106 or other processor such as ASIC may execute an application programming interface (“API”) (not shown in FIGS. 2-4) that interfaces with any resident programs or modules, such as first and resource monitoring engines 200 and 300 and resource re-allocation engine 400 and routines, sub-modules associated therewith or the like stored in the memory 104 of computing platform 102.

Processor 106 includes various processing subsystems (not shown in FIGS. 2-4) embodied in hardware, firmware, software, and combinations thereof, that enable the functionality of system 100 and the operability of the system on a network. For example, processing subsystems allow for initiating and maintaining communications and exchanging data with other networked computing platforms. For the disclosed aspects, processing subsystems of processor 106 may include any subsystem used in conjunction with first and resource monitoring engines 200 and 300 and resource re-allocation engine 400 and related algorithms, sub-algorithms, modules, sub-modules thereof.

Computer platform 102 may additionally include a communications module (not shown in FIGS. 2-4) embodied in hardware, firmware, software, and combinations thereof, that enables communications among the various components of the computing platform 102, as well as between the other networked devices. Thus, communication module may include the requisite hardware, firmware, software and/or combinations thereof for establishing and maintaining a network communication connection.

Memory 14 of computing platform 12 stores first resource monitoring engine 200 that is executable by processor 106 and configured to access historical resource utilization database 220, which according to embodiments of the invention, comprises a financial transaction database 228, to monitor 202 user records 222 pertaining to historical resource utilization 224 in the form of past financial transactions 226. Past or historical financial transactions 226 may include purchases, debit transactions, credits (e.g., paycheck deposits or the like), transfers, or the like undertaken by the user/customer in the recent pass. Such past historical financial transaction data 226 may indicate user transaction patterns, such as a user conducting a specific transaction on a regular basis, such as daily, weekly or the like. Moreover, historical financial transaction data 226 may indicate season purchases, such as holidays, birthdays/anniversary purchases that may need to be accounted for in determining whether a surplus truly exists in an account or whether the excess in an account is earmarked for the seasonal transaction/purchase. In addition past financial transaction data 226 may indicate/predict when a user/customer will see increase in an account balance based on automated paycheck deposit transactions or the like.

Further, first resource monitoring engine 200 is configured to access scheduled resource utilization database 230, which according to embodiments of the invention comprises, a scheduled financial transaction database 238, to monitor 204 user records 232 pertaining to future planned/scheduled resource utilization 234 in the form of scheduled financial transactions. Future scheduled financial transactions 236 may include future recurring payments (as indicated/determined by the past financial transaction data 226), future scheduled billpays (such as for credit accounts, utilities, mortgages or the like), future credits to an account (such as scheduled paycheck deposits or the like). As previously noted, based on system 100 configuration, first resource monitoring engine 200 may access databases 220 and 230 dynamically on a continuous or as-needed basis or may be configured to access the databases 220 and 230 on a predetermined schedule, such prior to the resource re-allocation engine 400 making a determination as to re-allocation volume/amount 404.

System 100 additionally includes resource re-allocation engine 400 that is stored in the stored in the memory 104, executable by the processor 106 and configured to make a logical determination 402 as to re-allocation amount 404 (i.e., the funds/assets to be automatically transferred) based on at least one of past financial transaction data 226 and/or scheduled financial transactions 236 and any other factors or relevant information known or accessible to the resource re-allocation engine 400. In this regard, the resource re-allocation engine 400 will identify and take into account transaction patterns in the past financial transaction data 226, such as regular purchases/transactions at a specified merchant (e.g., daily purchases at a convenient store, coffee shop or the like) or regular transactions of a certain type on a regular basis (e.g., weekly lunch out or the like) and make assumptions that upcoming funds will need to be available to account for such predicted future transactions. In addition, re-resource re-allocation engine will identify and account for all future scheduled financial transactions 236 occurring in the near future in determining whether a surplus currently exists in an account (or whether a future deficit will exist in the account).

Moreover, in addition to resource re-allocation engine 400 determining that a surplus exists in a lower yield account 212 (e.g., checking account/DDA or the like) that warrants transferring to another prospective higher yield account 222 (e.g., investment account/vehicle), resource re-allocation engine 400 may additionally be configured to determine that a future deficit will exists in a lower yield account 212 (e.g., checking account/DDA or the like) that warrants transferring/liquidating assets in a prospective higher yield account 222 (e.g., investment account/vehicle) and transferring the liquidated asset funds to the lower yield account e.g., checking account/DDA or the like).

In response to determining the re-allocation amount 404, the resource re-allocation engine 400 is configured to automatically re-allocate the determined surplus amount 404 from the lower yield account 212, such as a checking account/DDA to the prospectively higher yield account 222, such as an investment account/vehicle or the like or in the event that the determination results in a deficit amount 404 re-allocate resources from the prospectively higher yield account 222, such as an investment account/vehicle (i.e., liquidate assets or the like) to the lower yield account 212, such as a checking account/DDA. It should be noted that the prospectively higher yield account 222 may be an internal account (held at the same financial institution as the low yield account 212) or, in some embodiments of the invention, the investment account/vehicle may be an external account/vehicle (held at another financial institution or another entity).

Additionally, resource re-allocation engine 400 may be configured to generate and communicate alerts to the user in response to automatically re-allocating funds. The alert may indicate the re-allocated amount, the date of the re-allocation/transfer and the accounts affected. In addition, the resource re-allocation engine 400 may be configured to generate and communicate alerts to the user, prior to or in conjunction with a re-allocation, that identify transaction patterns and/or future scheduled transactions that may impact the current surplus or may result to an account deficit. In those embodiments of the invention in which the resource re-allocation engine 400 generates and communicates such alerts prior to automatic re-allocation, the user may be provided in the alert a means to acquiesce in the automatic re-allocation prior to initiating the automatic re-allocation/transfer of assets/funds.

Referring to FIG. 4, the system 100 may optionally store in memory 104 second resource monitoring engine 300 that is configured to monitor 202 resources 210 and/or 220 for performance indicators 302. In specific embodiments of the invention, second resource monitoring engine 300 is configured to monitor 202 prospectively higher yield accounts 222, such as investment accounts/vehicles for performance indicators 302 (e.g., indicators on whether performance of an investment account, stocks, commodities, real property or the like are trending upwards or downwards). It should be noted that second resource monitoring engine 300 may be configured to monitor 202 only those investment accounts/vehicles currently held by the users or, in other embodiments of the invention, the second resource monitoring engine 300 may be configured to monitor 202 other investment options/vehicles that are currently not held or otherwise being invested in by the users. Thus, the investment accounts 222 or other performance indicators that are monitored may be internal accounts/indicators and/or external accounts/indicators. External indicators may be news sources, crowd sourced data or any other relevant source for indicating performance of an investment vehicle, such as stocks, mutual funds, commodities, real property, or the like.

In such embodiments of the invention, resource re-allocation engine 400 is further configured to make logical determinations 406 of one or more of re-allocation timing 408 (e.g., when to invest or divest in an investment) and/or what type, or which specific, second resource 410 to re-allocate to or from (i.e., which specific investment account/vehicle or which investment account/vehicle type to invested or to divest from) based on the performance of the 302 of the investment accounts 222 or other factors, such as user interests, user needs, such as financial goals, tax benefits and the like.

In response to determining the re-allocation amount 404, and at least one of the re-allocation timing 408 and the type or specific second resource 410, the resource re-allocation engine 400 is configured to automatically re-allocate the determined surplus amount 404 from the lower yield account 212, such as a checking account/DDA to the determined prospectively higher yield account 222, such as an investment account/vehicle or the like at the predetermined time 408 or in the event that the determination results in a deficit amount 404 re-allocate resources from the determined prospectively higher yield account 222, such as an investment account/vehicle (i.e., liquidate assets or the like) to the lower yield account 212, such as a checking account/DDA at the predetermined time 408.

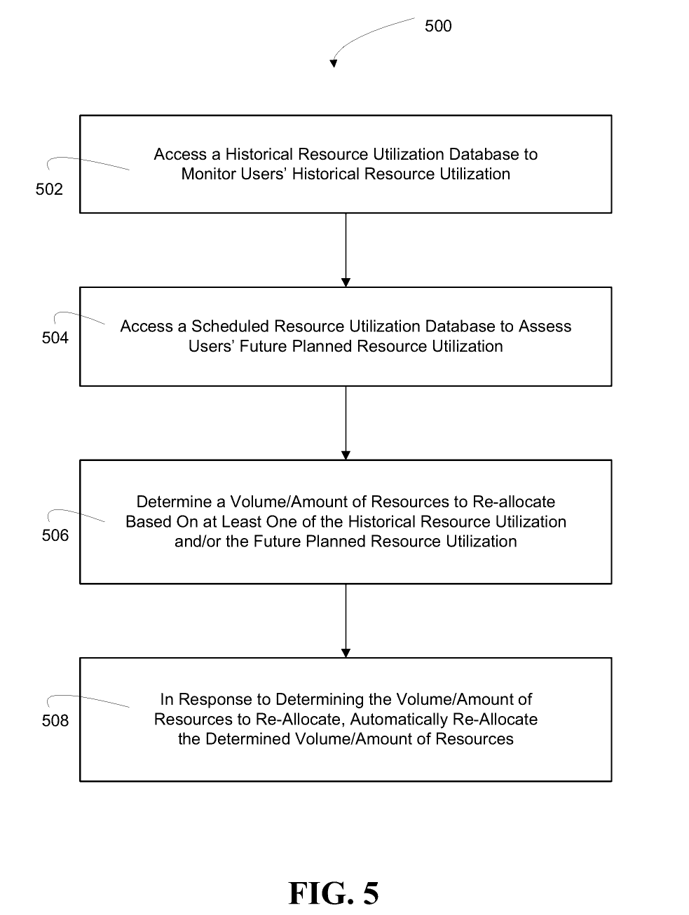

Referring to FIG. 5 a flow diagram is presented on a method 500 for resource re-allocation based on resource utilization, in accordance with embodiments of the present invention. At Event 502, historical resource utilization databases are accessed to monitor users' historical resource utilization. According to specific embodiments of the invention, financial transaction databases are accessed to monitor user's historical financial transactions to determine trends/patterns of transactions which users conduct in a regular basis and at regular identifiable times/dates.

At Event 504, scheduled resource utilization databases are accessed to assess/monitor users' future planned/scheduled resource utilization. According to specific embodiments of the invention, future scheduled financial transaction databases are accessed to identify user's future scheduled transactions, such as scheduled billpays, recurring payments, future account credits, such as automatic paycheck deposits and the like. Such identification allows for the present invention, to identify future needs for funds currently existing in an account, such as a checking account/DDA or the like.

At Event 506, the volume or amount of resources for re-allocation are logically determined based on at least one of the historical resource utilization and/or the future planned/scheduled resource utilization. In specific embodiments of the invention, the determination may include other factors. Moreover, the determined volume/amount may indicate a surplus or a deficit in a resource, which in turn, affects which direction the re-allocation occurs (i.e., from the lower yield account to the prospectively higher yield account or vice versa). According to specific embodiments of the invention, the amount of funds/assets to be transferred from one financial account/vehicle to another financial account/vehicle are determined based on at least one of user's financial transaction history and/or the user's future scheduled financial transactions.

At Event 508, in response to determining the volume/amount of resources to re-allocate, the determined volume/amount of resources are automatically re-allocated. In specific embodiments of the invention, such re-allocation entails automatically transferring funds/assets of the determined amount from a lower yield financial account, such as a checking account/DDA or the like to a prospective higher yield account, such as an investment account/vehicle or the like, or alternatively, automatically transferring funds/assets of the determined amount from a prospective higher yield account, such as an investment account/vehicle or the like to a lower yield financial account, such as a checking account/DDA or the like.

Thus, systems, apparatus, methods, and computer program products described above provide for automated resource re-allocation based on monitoring/assessing resource utilization. In specific embodiments of the invention, past/historical resource utilization is monitored and/or future/scheduled resource utilization is assessed to logically and intelligently determine the volume or amount resources available for automatic re-allocation. In other embodiments of the invention, performance of the resource is evaluated/determined to logically and intelligently determine the timing associated with the automatic re-allocation.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for automatic resource re-allocation based on resource utilization determination, the system comprising:
a computing platform including a memory and at least one computing processor in communication with the memory;
a historical resource utilization database stored in the memory and configured to catalog records of users' historical resource utilization;
a scheduled resource utilization database stored in the memory and configured to catalog records of users' future scheduled resource utilization;
a first resource monitoring engine stored in the memory, executable by the computing processor and configured to (1) access the historical resource utilization database to monitor users' historical resource utilization, and (2) access the scheduled resource utilization database to assess users' future planned resource utilization; and
a resource re-allocation engine stored in the memory, executable by the computing processor and configured to (1) logically determine a volume of resources to re-allocate based on at least one of users' historical resource utilization and future planned resource utilization, and (2) automatically re-allocate the determined volume of resources.

2. The system of claim 1, further comprising a second resource monitoring engine stored in the memory, executable by the computing processor and configured to monitor performance of users' resource allocation and wherein the resource re-allocation engine is furthered configured to (3) logically determine a timing for re-allocation of resources based on the performance of users' resource allocation and (2) automatically re-allocate the determined volume of resources in accordance with the determined timing for re-allocation.

3. The system of claim 1, wherein the historical resource utilization database is further defined as a transaction history database that is configured to catalog records of users' transaction history,
wherein the first resource monitoring database is configured to access the transaction history database to monitor users' transaction history, and
wherein the resource re-allocation engine is configured to logically determine the volume of resources to re-allocate based on a users' transaction history.

4. The system of claim 1, wherein the scheduled resource utilization database is further defined as a future transaction database that is configured to catalog records of users' future scheduled transactions,
wherein the first resource monitoring database is configured to access the future transaction database to assess users' future scheduled transactions, and
wherein the resource re-allocation engine is configured to logically determine the volume of resources to re-allocate based on a users' future scheduled transactions.

5. The system of claim 2, wherein the second resource monitoring engine is configured to monitor performance of users' resource allocation, wherein the resource allocation is an investment resource allocation and wherein the resource re-allocation engine is furthered configured to (3) logically determine a timing for re-allocation of resources based on the performance of users' investment resource, and (2) automatically re-allocate the determined volume of resources in accordance with the determined timing for re-allocation.

6. The system of claim 1, wherein the resource re-allocation engine is further configured to automatically re-allocate the determined volume of resources, wherein lower yield resources are re-allocated to a prospectively higher yield resource.

7. The system of claim 1, wherein the resource re-allocation engine is further configured to automatically re-allocate the determined volume of resources, wherein prospectively higher yield resources are re-allocated to lower yield resource.

8. A computer-implemented method for automatic resource re-allocation based on resource utilization determination, the method comprising:
accessing, by a computing device processor, a historical resource utilization database to monitor users' historical resource utilization;
accessing, by a computing device processor, a scheduled resource utilization database to assess users' future planned resource utilization;
determining, by a computing device processor, a volume of resources to re-allocate based on at least one of users' historical resource utilization and future planned resource utilization; and
in response to determining the volume of resources to re-allocate, automatically re-allocating, by a computing device processor, the determined volume of resources.

9. The method of claim 8, further comprising monitoring, by a computing device processor, performance of users' resource allocation

10. The method of claim 9, further comprising determining, by a computing device processor a timing for re-allocation of resources based on the performance of users' resource allocation and, wherein automatically re-allocating further comprises automatically re-allocating, by the computing device processor, the determined volume of resources in accordance with the determined timing for re-allocation.

11. The method of claim 8, wherein accessing the historical resource utilization database further comprises accessing, by the computing device processor, a transaction history database that is configured to catalog records of users' transaction history, and wherein determining the volume of resources to re-allocate further comprises determining, by the computing device processor, the volume of resources to re-allocate based on a users' transaction history.

12. The method of claim 8, wherein accessing the scheduled resource utilization database further comprises accessing, by a computing device processor, a future transaction database that is configured to catalog records of users' future scheduled transactions, and wherein determining the volume of resources to re-allocate further comprises determining, by the computing device processor, the volume of resources to re-allocate based on a users' future scheduled transactions.

13. The method of claim 12, wherein monitoring performance of users' resource allocation further comprises monitoring, by the computing device processor, performance of users' investment resource allocation.

14. The method of claim 13, wherein determining the timing further comprises determining, by the computing device processor, the timing for re-allocation of resources based on the performance of users' investment resource, and wherein automatically re-allocating further comprises automatically re-allocating, by a computing device processor, the determined volume of resources in accordance with the determined timing for re-allocation.

15. The method of claim 8, wherein automatically re-allocating further comprises automatically re-allocating, by the computing device processor, the determined volume of resources from a lower yield resource to a prospectively higher yield resource.

16. The method of claim 8, wherein automatically re-allocating further comprises automatically re-allocating, by the computing device processor, the determined volume of resources from a prospectively higher yield resource to a lower yield resource.

17. A computer program product comprising:
a non-transitory computer-readable medium comprising:
a first set of codes for causing a computer to access a historical resource utilization database to monitor users' historical resource utilization;
a second set of codes for causing a computer to access a scheduled resource utilization database to assess users' future planned resource utilization;
a third set of codes for causing a computer to determine a volume of resources to re-allocate based on at least one of users' historical resource utilization and future planned resource utilization;
a fourth set of codes for causing a computer to, in response to determining the volume of resources to re-allocate, automatically re-allocate the determined volume of resources.

18. The computer program product of claim 17, further comprising a fifth set of codes for causing a computer to monitor, by a computing device processor, performance of users' resource allocation and a sixth set of codes for causing a computer to determine a timing for re-allocation of resources based on the performance of users' resource allocation.

19. The computer program product of claim 18, wherein the fourth set of codes is further configured to cause the computer to automatically re-allocate the determined volume of resources in accordance with the determined timing for re-allocation.

20. The computer program product of claim 17, wherein the first set of codes is further configured to cause the computer to access a transaction history database that is configured to catalog records of users' transaction history, and wherein the third set of codes is further configured to cause the computer to determine the volume of resources to re-allocate based on a users' transaction history.
